(19) United States
(12) Patent Application Publication
(10) Pub. No.: US 2003/0016368 A1
(43) Pub. Date: Jan. 23, 2003

(54) Visibly transparent retroreflective materials

(76) Inventors: James A. Aman, Soudeston, PA (US); William R. Halles, Bethlehem, PA (US)

Correspondence Address: James A. Aman, 134 Bridle View Way, Soudeston, PA, 18964, US

(21) Appl. No.: 09/911,043

(22) Filed: Jul. 23, 2001

(51) Int. Cl. G01B 11/14

(52) U.S. Cl. 356/615

(57) ABSTRACT

A retroreflective material 100, 101, 102 and 103 that comprises a retroreflective element 20, 20uv and 20ir that is adapted to transmit energy from the visible spectrum while simultaneously reflecting energy from the non-visible spectrum such as UV or IR. In their microspheric optical body form, the materials 100, 101, 102 and 103 comprise a substantially visibly transparent microscopic bead 22 underneath which a reflector 24, 24uv and 24ir is placed. Reflector 24uv narrowly reflects some or the entire ultraviolet spectrum while reflector 24ir narrowly reflects some or the entire IR spectrum. Generic reflector 24 may reflect a sub-portion of the visible spectrum such as red light. Materials 100, 101, 102 and 103 may be augmented with fluorescent compounds embedded within either bead 22f itself or into a fluorescent matrix layer 23 placed between the underside of bead 22 and reflector 24, 24uv and 24ir forming fluorescent retroreflective materials 104 and 105.

### FIELD OF INVENTION

The present invention relates to retroreflective elements such as glass microspheres with hemispheric specular reflectors as well as to machine vision systems and devices that employ non-visible electromagnetic energies.

### BACKGROUND OF THE INVENTION

Retroreflective materials are well known in the prior art and were created to substantially increase the visibility of the objects to which they were applied. There are essentially two types of retroreflective materials: cube cornered and beaded.

Cube cornered retroreflective materials comprise a body portion having a substantially planar base surface and a structured surface comprising a plurality of cube corner elements opposite the base surface. Each cube corner element comprises three mutually substantially perpendicular optical faces that intersect at a single reference point, or apex. The bottom edges of the optical faces define the base of the cube corner element, which acts as an aperture through which light is transmitted into the cube corner element. In use, light incident on the base surface of the material is refracted at the base surface, transmitted through the bases of the cube corner elements, reflected from each of the three perpendicular cube corner optical faces, and then redirected toward the light source. The symmetry axis, also called the optical axis, of a cube corner element is the axis that extends through the cube corner apex and forms an equal angle with the three optical surfaces of the cube corner element. Cube corner elements typically exhibit the highest optical efficiency in response to light incident on the base of the element, roughly along the optical axis. The amount of light retroreflected by a cube corner retroreflector drops as the incidence angle deviates from the optical axis.

Beaded materials typically comprise microscopic glass spheres whose lower hemisphere has been coated with a reflective compound such as aluminum or silver, or with a dielectric material such as alternating layers of zinc sulfides and cryolite. These retroreflective elements function by first receiving light into the transparent upper hemisphere where it is then transmitted through the glass element to a point on the lower hemisphere. Upon striking the reflective material coating on the outside of the lower hemisphere, this light is then redirected back towards the upper hemisphere at substantially the same angle as that of the incident energy. From the optics perspective, beaded materials typically exhibit favorable rotational symmetry and entrance angularity performance because of the symmetrical nature of the beads. Additionally, beaded materials typically exhibit relatively good flexibility because the beads are independent from one another.

The actual form of the optical body of the retroreflective element is immaterial to the teachings of the present invention. Compounds other than aluminum, silver and dielectric materials may be used as reflectors for current examples of optical bodies. The commonality shared by the state of the art and prior teachings of retroreflective materials is that they are reflective at least within the spectrum of visible light, i.e., covering some or all of the electromagnetic radiation from 400 nm through 700 nm. Due to the individual properties of current retroreflective materials, some of the state of the art retroreflective elements will also reflect a portion of the non-visible frequencies such as UVA energy from 320 nm to 400 nm or near-infrared energy from 700 nm to 900 nm.

Typical applications for which retroreflective materials were created include increasing the nighttime visibility of signs or clothing to oncoming traffic. Other applications include machine vision object tracking systems such as the “RealTime HiRES 3D System”developed by Motion Analysis Corporation. Their system employs retroreflective markers that are attached to the person or object whose motion is to be tracked. One or more cameras fitted with light rings are then used to follow the object's movement. These light rings are designed to mount over the outside edge of the camera lens thereby placing the light source as close as possible to the camera. The light sources in the Motion Analysis system emit red light within the visible spectrum. The retroreflective materials that they use as markers are designed to reflect all of the visible frequencies and adequately return the emitted red light to the tracking cameras. However, this broad spectrum reflectivity is in fact a limitation since the markers will reflect all incoming visible light, not just the intended tracking frequencies. This is a contributing cause for their system to be “lab based” as opposed to “live environment” capable. Hence, these same markers will reflect visible light from any source. In the case where such a system would be employed to track a live sporting event such as ice hockey, these other light sources would typically include existing rink lighting as well as camera flashes. The random retroreflections of these light sources from the tracking markers would represent significant system noise, annoyance to viewing fans and a potentially harmful condition to the athletes and game officials.

The present inventors are aware that systems of similar construction to the HiRES 3D from Motion Analysis Corporation are also commercially available from at least five other companies including:

Ariel Dynamics, Inc. with their APAS system;

Peak Performance Inc. with their Motus system;

Elite with their 3D Motion Analysis System;

Qualisys with their ProReflex system, and

Vicon with their Vicon 250 and 512 3D motion analysis systems.

Each of these systems is known to be based upon a similar broad visible spectrum retroreflective marker in combination with a light source emitting a narrow band of frequencies to be used as tracking energy. These markers are readily available from manufacturers such as the 3M Company.

In their co-pending application Ser. No. 09/197,219 entitled Multiple Object Tracking System that was filed on Nov. 20, 1998, the present inventors have overcome the problems with visible light based tracking systems such as previously described. The disclosure of this earlier application is incorporated by reference. In their application, they disclose a unique system for following the motion of players and equipment within a sporting contest using non-visible energy such as ultraviolet and frequency selective reflective markings. In their subsequent additional co-pending application entitled Employing Electromagnetic By-product Radiation for Object Tracking filed on Jun. 14, 2001, the present inventors further taught the use of existing retroreflective materials to increase the reflected signal strength of the non-visible tracking energy. The disclosure of this earlier application is incorporated by reference. However, the current state of the art in retroreflective materials is not ideal in that they also and mainly reflect visible light. What is needed to optimize non-visible light machine vision systems is to have a retroreflective material that is substantially transparent to visible light and yet highly reflective to the selected non-visible tracking frequency such as ultraviolet or infrared.

An additional problem persists with state of the art motion analysis systems such as HiRES 3D in that, while the use of typical retroreflective materials ideally provides increased reflected signal over diffuse reflective surfaces, it also necessarily limits observation angles. Hence the requirement in Motion Analysis Corporation's system for the use of ring lights that circle the lens and emit the desired tracking energy. By remaining as close to the tracking camera's lens as possible, the amount of retroreflected energy received into the camera's CCD (charge coupled device) array is maximized. As was specified by the present inventors in their copending application Employing Electromagnetic By-product Radiation for Object Tracking, it is ideal to employ the unused UVA energy being emitted by existing facility lighting rather than adding new tracking energy. Under these assumptions, the facility lighting is already in place within the arena where the tracking system cameras are to be installed. Ideal placement of these cameras will be at least in a uniform grid substantially above the playing surface and may not correspond to the closest proximity between lighting and camera. Given this practical requirement, what is needed is a retroreflective material that in addition to being able to retroreflect only the non-visible tracking energy, is of a construction allowing for higher degrees of angular observation. Such materials are known and are taught for microspheres in U.S. Pat. No. 5,777,790 (Nakajima) and for cube corners in U.S. Pat. No. 4,703,999 (Benson) and U.S. Pat. No. 5,898,523 (Smith et al.).

While the present invention will be specified in reference to one particular example of retroreflective materials as will be described forthwith, this specification should not be construed as a limitation on the scope of the invention, but rather as an exemplification of preferred embodiments thereof. The inventors envision many additional variations for the construction of visibly transparent and optionally wide observation angle retroreflective materials, only some of which will be mentioned in the conclusion to this application's specification. For purposes of teaching the novel aspects of this invention, the example of encapsulated microspheres will be used.

A typical retroreflective material consists of retroreflective elements suspended in a binder that essentially holds the elements in place on the substrate, e.g., fabric, plastic, metal, etc. These elements are themselves typically an assembly of at least an optical body such as a microsphere whose lower surface, or in this instance lower hemisphere, has been coated with a reflector such as aluminum or silver. Glass or synthetic resin are most often used to form these microspheres and are chosen due to their high transparency to visible light. Glass is preferred to polymeric microspheres because glass typically costs less, is harder, exhibits superior durability, and provides better optical efficiency. Aluminum and silver are most often used as reflectors because of their high reflectivity to visible light. Silver reflectors provide increased reflectance while aluminum provides increased durability. This entire assembly may itself be further encapsulated within a water-impermeable coating that acts to protect the reflector from degradation due to environmental exposure. Such coatings have been formed from materials made up primarily of metal or metalloid cations and oxygen as taught in U.S. Pat. No. 5,673,148 (Morris et al.). Typically the protective coating is titanium dioxide, silicon dioxide, aluminum oxide, or a combination thereof. Each of these coatings is transparent to visible light. And finally, the retroreflective assemblies are suspended in a binder material such as a durable polymeric material.

It is possible to replace the aluminum or silver reflectors with other compounds that are reflective of a non-visible energy such as ultraviolet and yet still transmissive to visible light. Two well-known examples of such compounds are titanium dioxide and zinc oxide.

New technological advances have led to the development of UV reflectors made of particles so small that the human eye does not perceive them and yet they still reflect UV light.

A company called Collaborative Laboratories produces one such example of these microscopic physical blockers. Their general class of products is referred to as “Micronized Titanium Dioxide” that they describe as having the following benefits:

“What are the advantages of micronized titanium dioxide and how can using TiOsperse™ offer formulators an array of benefits for their finished formulations? The benefits you will derive are:

Extremely small particle size

Transparent to visible light

Greater surface area

Reflects and scatters UV light more effectively than pigmentary titanium dioxide.”

Another example of a new UV reflective material is described by its manufacturer CLCEO Corp. as follows:

“a revolutionary new technology for fabricating a broadband, thin film reflective circular polarizer having previously unheard-of properties. The reflection band of this polarizer can be engineered to any portion of the spectrum from the UV through the near-infrared. The films can also be broken into thin flakes for incorporation into heat and UV protective paints and balms, and can be used as completely colorless IR and UV reflective films . . .

. . . This polarizer material is unique in that it can be applied as a uniform film or (using a Reveo proprietary process) it can be broken into smaller flakes that are then distributed as a pigment in a carrier. A CLC IR film can be applied directly to architectural or automotive windows to minimize heat transmission through the window. Since this film is totally transparent in the visible region, it is haze-free and does not interfere with the aesthetic qualities or degrade the brightness of the window. Similarly, a protective UV reflecting film can be applied to reduce solar UV-induced fading and aging of fabrics and other materials.

An IR-reflecting paint can be fabricated into a clear overcoat for virtually any surface. In architectural applications, for example, it would enable an exterior painted building surface to reflect the heating portion of solar radiation. Presently, buildings in hot climates are painted white or light colors to prevent solar heating during the day. A transparent, IR reflecting overcoat will enable architects and designers to use the color of their choice, while at the same time minimizing solar heating and the load on the building's cooling system.

Another application is in suntan lotion and related products. Here the IR-reflecting flakes can provide an unprecedented cooling effect for the consumer. Furthermore, published reports indicate that most sunscreen lotions protect only against UVB radiation. A lotion incorporating the Reveo UV-reflecting flakes can provide heretofore unheard-of complete UVA and UVB protection in a colorless, non-toxic lotion.”

And finally, The Boeing Company has also created UV reflective materials that they describe as follows:

“In two filings now before the US Patent and Trademark Office, McDonnell Douglas has disclosed various multilayer dielectric thin film structures, deposited on glass, plastic or metal, which reflect greater than 99% of longwave UV while improving transmittance in the visible rather than decreasing it as may be the case with other UV blocking methods. Reflectance is reduced to less than 0.5% over most of the visible spectrum as compared to 4% reflectance typical for uncoated glass or plastics.

Since the coatings work by reflection rather than absorption, no heating effects are produced. The broadband AR coating results in a nearly neutral color to the eye in transmission. This coating, externally applied, can be used on a wide variety of materials, and tailored to specific needs.”

Any of these aforementioned new or existing UV and IR reflective compounds may be used as reflectors to coat the lower hemispheres of the glass microbeads forming the retroreflective element. The present invention teaches the use of these and other compounds of similar reflective qualities in order to limit the “visibility” of the resultant retroreflective material to a selected narrow energy band preferably in the non-visible UV or IR spectrum.

As was previously discussed, existing state of the art machine vision applications such as the HiRes8 system from Motion Analysis Corporation employ retroreflective materials to help track complex object movement using visible red light. Motion Analysis Corporation will also configure their system to work with non-visible infrared light. One of the main reasons that Motion Analysis chooses not to use their IR light source is that it does not emit any visible light. Due to the lack of this visual indicator, people in the area of the system may inadvertently stare at this light source and potentially damage their retina from overexposure to the non-visible IR energy. The present inventors' copending application entitled Employing Electromagnetic By-product Radiation for Object Tracking overcomes this problem by specifying the use of light sources that both illuminate the playing surface with visible light and additionally emit a non-visible frequency of either UVA or IR energy that can be employed for object tracking.

The present inventors are aware of a commercially available product known as “glint tape” that addresses a portion of the same “IR-only” retroreflective purposes as the disclosed invention via a different material construction. One manufacturer of glint tape is Brosi Sign Systems, Inc. of White Bear Lake, Minn. Night Vision Equipment Corporation, a Brosi distributor, describes the glint tape, which they market as “Warrior GloTape,” as follows:

“Warrior GloTape is an infrared (IR) reflective material designed for the covert combat identification (CID) marking of vehicles, troops and fixed positions. To the naked eye, Warrior GloTape appears to be black duct-tape in finish and texture. When illuminated with a bright visible light, the GloTape exhibits no special reflective characteristics. However, when illuminated with an infrared (IR) source, the tape glows brightly. The IR glow is visible only to night vision devices. Thus, a night vision goggle user could readily see the bright retroreflection of the Ground Commander's Pointer—Warrior Dot, for example. The tape also operates at the 1.06 micron wavelength, the operating band of the laser designators used with smart munitions.”

This material is constructed of a traditional visible and IR energy retroreflecting cube-corner tape that has essentially been painted black. The black finish coat functions to absorb the visible light while simultaneously substantially transmitting the IR energy through into the retroreflectors and then back out towards the light source. While this has limited applicability, when used with partially embedded microspheric bead based retroreflective material the painted on black coating can adversely effect optimum retroreflective properties.

What is needed is a retroreflective material whose reflective elements are transmissive to visible light while being simultaneously reflective to a restricted band of non-visible energy such as UV, UVB, UVA, near-IR or far-IR. Such a material may be visibly transparent or may take on the pigment of the substrate to which it will be attached without concern for its absorptive properties to visible light. It should be noted that the thin film reflective circular polarizer created by CLCEO Corp. can be created to reflect infrared in addition to ultraviolet thereby providing an ideal compound to be used within the retroreflective material.

As was taught in the copending application entitled Employing Electromagnetic By-product Radiation for Object Tracking, another possible solution for the creation of a tracking signal is the use of fluorescent materials. The properties of a fluorescent compound are such that it will receive energy of a higher frequency and then upon absorption of this energy emit energy of a lower frequency. Examples of fluorescent materials are laser dyes some of which absorb energy about 330 nm and emit at about 390 nm. Note that in this case the absorption and fluorescence all take place in the non-visible spectrum. There are other dyes that are capable of absorbing visible light at frequencies about 680 nm and emitting IR light at about 715 nm. The actual dyes and wavelengths are immaterial to the teachings of this application and the copending application. What is important is that there are compounds that can fluoresce in the UV or IR regions. These compounds could be used to create a material similar in construction and function to the retroreflective materials previously described and herein taught. For instance, a matrix layer comprising one of these types of laser dyes held in a solvent such as a polymer could be placed between the microscopic bead's lower hemisphere and the reflector. As light rays enter the bead they will be directed to some point on the lower hemisphere where they will first strike the laser dye matrix. Upon absorption of sufficient energy, these dyes will then either fluoresce or lase. This energy of a lower frequency will be emitted omni-directionaly over a 360° range. However, given the reflector placed beneath the laser dye, all of the emitted energy will be directed back up through the bead generally in the direction of the incident energy. As an alternative, when using polymer or resin based microscopic beads, the laser dye could actually be embedded within the bead itself as opposed to being placed on the lower hemisphere as an additional layer.

Therefore, given the state of the art in non-visible energy reflective compounds as well as retroreflective technology it is possible to create materials that are substantially transmissive to visible light while at the same time retroreflective to a non-visible energy such as ultraviolet or infrared. For the purposes of teaching this new art the present application will refer to a machine vision system for tracking multiple objects, in this case players and equipment within a live sporting event such as ice hockey, to which the newly disclosed visibly transparent retroreflective materials have been attached.

Objects and Advantages

Accordingly, the objects and advantages of the present invention are to provide a novel retroreflective material capable of:

1 providing retroreflective elements that retroreflect electromagnetic energy outside of the visible spectrum, especially including ultraviolet and infrared energy, while remaining substantially transparent to visible light;

2 providing retroreflective elements that retroreflect a narrow band of visible energy, for instance red light, while remaining substantially transparent to all other electromagnetic energy;

3 providing a retroreflective element that employs fluorescent materials to receive incident energy about one wavelength and emit energy about a second tracking wavelength, where the emitted energy is generally reflected back in the direction of the incident energy;

4 retroreflecting two or more different bands of electromagnetic energy;

5 performing all of the advantageous functions and having all of the beneficial features characteristic of known retroreflective materials, especially that of having a wide angle of observation.

Still further objects and advantages of the present invention will become apparent from a consideration of the drawings and ensuing detailed description.

### DESCRIPTION OF THE DRAWINGS

FIG. 1 is a side view of a typical High Intensity Discharge (HID) lamp of the type often used to illuminated large open spaces such as a sporting arena or facility, further depicting the spread of emitted electromagnetic frequencies ranging from ultraviolet, through visible light into infrared. Also shown are three variably oriented retroreflective elements partially embedded in a single binder that has been joined to a substrate. The elements and binder have been depicted as transmissive to visible light while the substrate is reflective. In response to the non-visible frequencies of either ultraviolet or infrared, at least some of the elements are retroreflective while the substrate remains reflective.

FIG. 2a is a side view of the preferred embodiment showing the encapsulated retroreflective microsphere partially embedded in its binder.

FIG. 2b is a side view of the preferred embodiment showing the encapsulated retroreflective microsphere fully embedded in its binder.

FIG. 2c is a side view of an alternative embodiment showing a non-encapsulated retroreflective microsphere partially embedded in its binder.

FIG. 2d is a side view of the alternative embodiment showing a non-encapsulated retroreflective microsphere fully embedded in its binder.

FIG. 3a is a side view of an alternative embodiment showing an additional fluorescent matrix layer placed between the microsphere and the reflector.

FIG. 3b is a side view of an alternative embodiment showing a fluorescent microsphere in place of a typically transparent microsphere.

FIG. 4 is a top view of one application of the present invention depicting an array of overhead X-Y tracking cameras, that when taken together, form a field of view encompassing the skating and bench area within an ice hockey arena. Also depicted are perspective Z tracking camera sets behind each goal, automatic pan, tilt and zoom perspective filming cameras, as well as a single representative player and puck.

FIG. 5a is a set of three perspective views depicting a typical player's jersey, typical player's pads with tracking patches in place and then a combination of the jersey over the pads with patches.

FIG. 5b is a set of two perspective views depicting a hockey puck as well as a typical player's hockey stick, where each has been augmented to include tracking ink on at least some portion of its outer surfaces.

FIG. 5c is a set of two perspective views depicting a typical hockey player's helmet which has been augmented to include tracking stickers on at least some top portion of its outer surface.

FIG. 6a is a perspective view of a typical hockey player's pads, helmet, stick and puck being captured from an overhead X-Y filming camera and displayed on a viewing screen.

FIG. 6b is a perspective view similar to FIG. 6a except that now tracking ink has been added to the hockey stick and puck, tracking patches have been added to the pads and tracking stickers to the helmet. In addition, a tracking energy source as well as a frequency-matching filter have been added to the overhead X-Y filming camera making it a tracking camera.

FIG. 6c is a perspective drawing similar to FIG. 6b except that now all of the foreground objects except the tracking marks have been treated with a energy absorptive compound. This compound is capable of absorbing the non-visible frequencies of energy that are being used by the tracking system.

### DETAILED DESCRIPTION

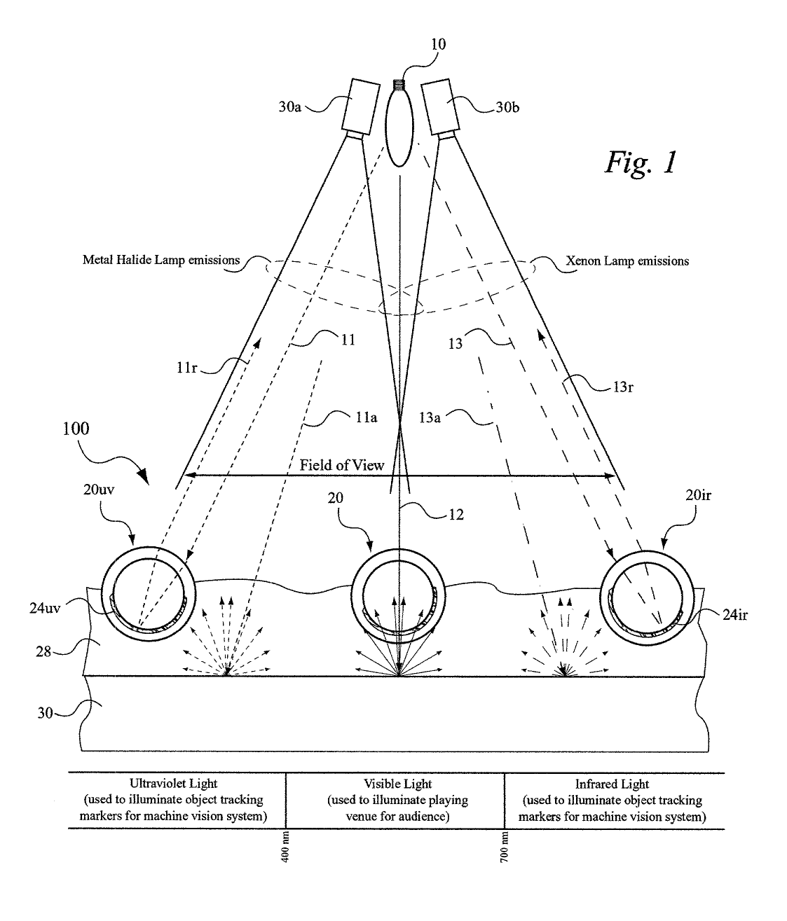

Referring now to the drawing, in which like reference numbers refer to like elements throughout, FIG. 1 shows a side view of a typical HID lamp 10 as might be used to illuminate a live sporting event such as hockey. Two examples of lamp 10 are either a metal halide lamp or a xenon arc lamp. Within a live sporting event, lamps 10 such as these types are primarily used to illuminate the playing surface for the audience and as such emit electromagnetic energy in the visible light spectrum between the frequencies of 400 to 700 nm as depicted by visible light ray 12. Ray 12 will propagate through the atmosphere until passing through the generic retroreflective element 20, binder 28 and then striking substrate 30 where it is reflected.

In the case where rink lamp 10 is of the metal halide type then an additional by-product UV energy 11 is also emitted. Ray 11 will propagate through the atmosphere until entering retroreflective element 20uv and striking UV reflector 24uv subsequently causing retroreflected UV energy ray 11r. In the case where HID lamp 10 is of the xenon lamp type then an additional by-product such as unused IR energy 13 is also emitted. Ray 13 will propagate through the atmosphere until entering retroreflective element 20ir and striking IR reflector 24ir subsequently causing retroreflected IR energy 13r. Both retroreflected rays 11r and 13r are then received by either or both machine vision cameras 30a and 30b. Additional UV ray 11a and IR ray 13a are shown to propagate through the atmosphere and to miss retroreflective elements 20uv and 20ir, respectively, both passing through binder 28 until striking substrate 30 where they are reflected. Taken together, the monolayer of retroreflective elements 20uv, 20 and 20ir which are partially embedded in binder 28 form the preferred embodiment of the novel visibly transparent retroreflective material 100.

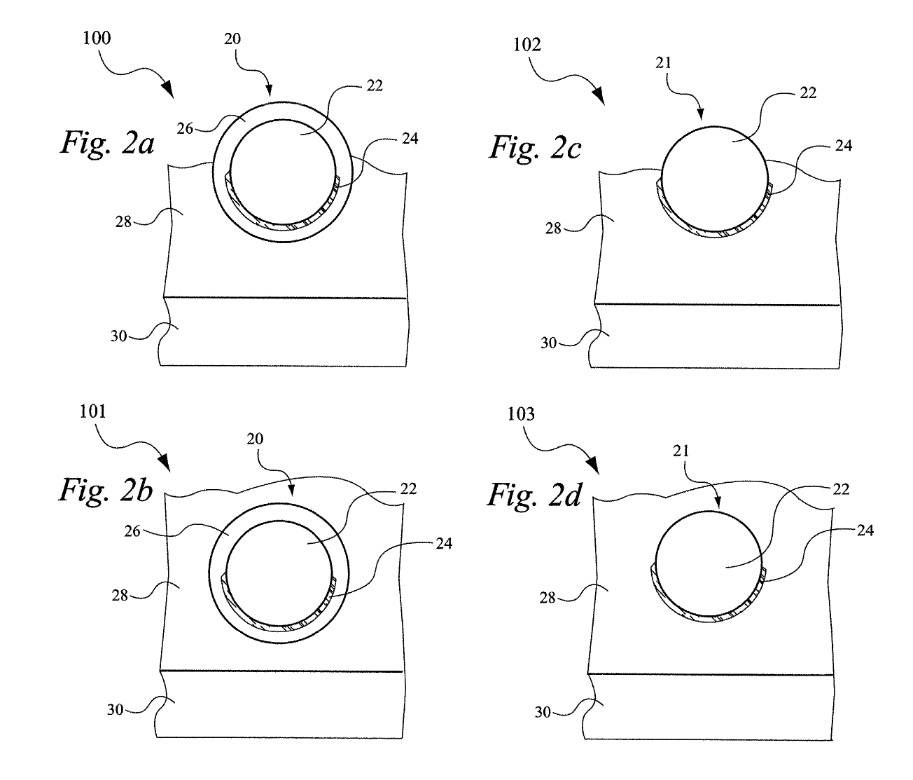

Referring now to FIG. 2a, the preferred embodiment of retroreflective material 100 is shown to consist of encapsulated generic retroreflective element 20 that is itself partially embedded into binder 28. Binder 28 is shown attached to substrate 30; as a matter of practice, however, the actual existence or composition of the substrate 30 is immaterial to the teachings of the present invention. Generic retroreflective element 20 further comprises a microscopic bead 22 whose lower hemisphere is coated with a reflector 24. Then entire bead 22 and reflector 24 are further encapsulated by coating 26 that serves to help prevent environmental degradation.

Referring now to FIG. 2b, alternate embodiment 101 is shown. Embodiment 101 is similar to preferred embodiment 100 except that encapsulated generic retroreflective element 20 is entirely embedded within binder 28.

Referring now to FIG. 2c, alternate embodiment 102 is shown. Embodiment 102 is similar to preferred embodiment 100 except that encapsulated generic retroreflective element 20 has been replaced by non-encapsulated generic retroreflective element 21 that simply comprises bead 22 and reflector 24.

Referring now to FIG. 2d, alternate embodiment 103 is shown. Embodiment 103 is similar to alternate embodiment 102 except that non-encapsulated generic retroreflective element 21 is entirely embedded within binder 28.

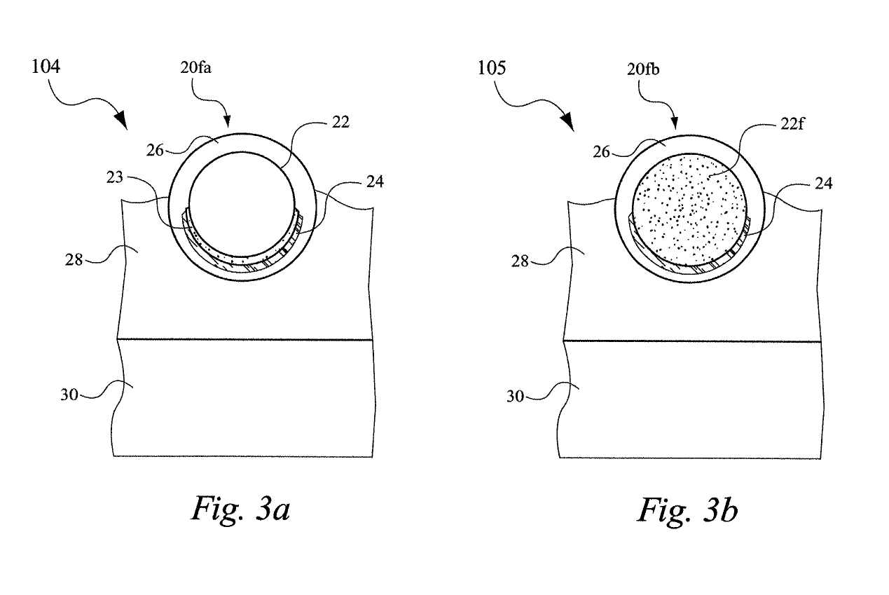

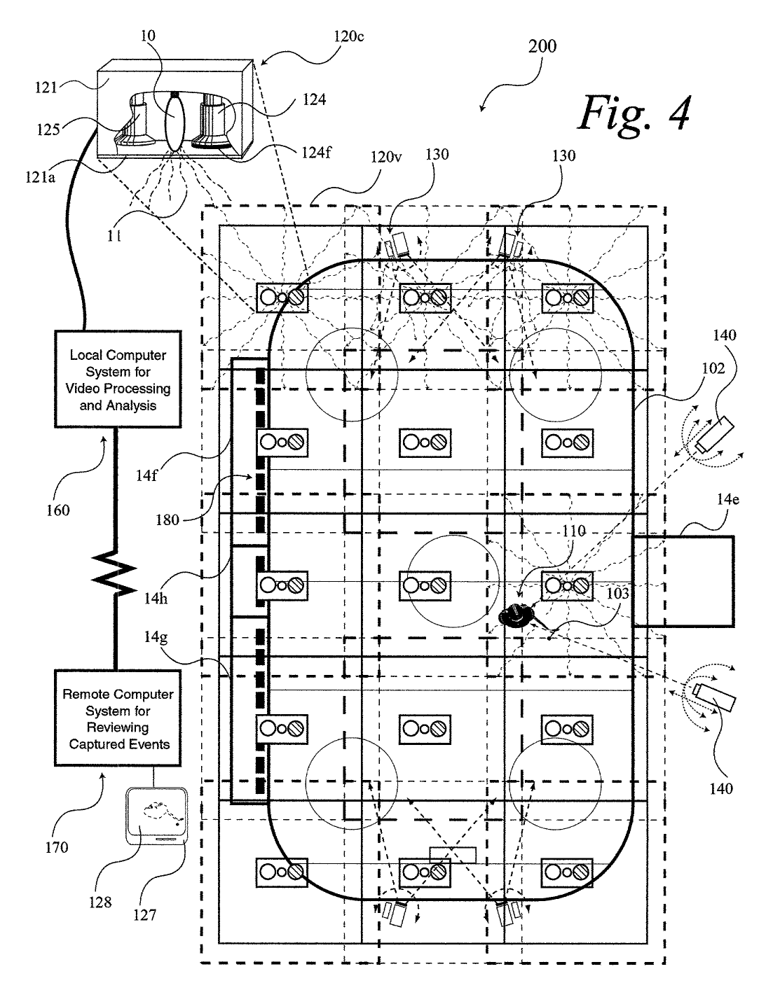

Referring now to FIG. 3a, alternate embodiment 104 is shown. Embodiment 104 is similar to the preferred embodiment 100 except that retroreflective element 20fa additionally comprises a fluorescent matrix 23 that has been placed between microscopic bead 22 and reflector 24.

Referring now to FIG. 3b, alternate embodiment 105 is shown. Embodiment 105 is similar to the preferred embodiment 100 except that retroreflective element 20fb comprises a microscopic fluorescent bead 22f instead of transparent bead 22.

Operation

Referring first to FIG. 2c, normal operation of the preferred embodiment is dependent upon the unique construction of the retroreflective material such as 102. There are three basic components to any microspheric retroreflector: the binder 28, the microscopic bead 22 and the reflector 24. From this construction many variations have been taught in the prior art. Some of these variations concern the physical construction of the material such as the degree to which the retroreflective element such as 21 is embedded within the binder 28. For example, referring now to FIG. 2d, there is shown an alternate embodiment 103 of a retroreflective material where the retroreflective element 21 is fully embedded within the binder 28.

Referring now to FIG. 2a there is shown the preferred embodiment that differs from the basic construction illustrated in FIG. 2c because the retroreflective element 20 has now been encapsulated with coating 26. U.S. Pat. No. 5,673,148 (Morris et al.) teaches encapsulating the retroreflective element within a dense, continuous, water-impermeable, preferably substantially transparent oxide coating. Typically the protective coating is one of the following: titanium dioxide, silicon dioxide, aluminum oxide, or a combination thereof. Coatings formed in accordance with these teachings are typically quite smooth so as to be optically clear. Furthermore, coatings that are too thin may tend to provide insufficient protection from corrosion. Coatings that are too thick may tend to be less transparent and/or exhibit more light scattering, thus resulting in reduced retroreflective brightness for the resultant retroreflective element.

Referring now to FIG. 2b there is shown an alternate embodiment 101 of material 100 that fully embeds retroreflective element 20 within binder 28. In all embodiments 100, 101, 102 and 103 the binder is attachable to a substrate 30 that itself is not considered to be a part of the retroreflective material and most probably is not transparent to visible light but rather reflective as depicted in FIG. 3.

In addition to physical variations such as those just discussed, the prior art teaches chemical variations in each of the basic components of a retroreflective material. For instance, the microscopic bead 22 may be constructed of either glass or synthetic resin as

preferred by Morris et al. The reflector 24 is typically either aluminum or silver. It should be noted that while both the glass and synthetic resin options are substantially transparent to visible light, the aluminum and silver options are intentionally reflective to the visible spectrum. It is this reflective nature that works in combination with the shape of the transparent microbead to cause the retroreflection of visible light.

However, it is possible to employ new compounds such as micronized titanium dioxide produced by Collaborative Laboratories, the polarizer material developed by CLCEO Corp., or the multilayer dielectric thin film structures patented by McDonnell Douglas as the reflector 24. As disclosed in the background of the present application, these compounds are unique in that they reflect either UV or IR light and are substantially transmissive to visible light. The present inventors only suggest these compounds as examples and anticipate the use of other existing or yet to be developed compounds that perform essentially the same function of controllably reflecting a select band of non-visible light such as ultraviolet and/or infrared. Furthermore, it is also anticipated that there are significant benefits to employing a compound that is reflective to a narrow band of visible energy, for instance red light, as opposed to the entire visible spectrum. At least the polarizer material developed by CLCEO could be used for this purpose.

The binder 28 may be constructed of matrix materials of many variations as taught throughout the prior art. Typically the binder 28 will comprise a durable polymeric material that provides good adhesion to the microspheres and preferably also to the other elements of the retroreflective material, e.g., reflector 24, coating 26 and substrate 30. In the preferred embodiment, the binder 28 is a flexible layer allowing the resultant material to be bent and formed during handling and shaped into non-planar configurations. Visibly transparent binders are preferable but other options include matrix materials to which select pigment particles have been added in order to create a visual appearance of the binder 28 to match the anticipated color of the substrate 30. For instance, the binder 28 may further comprise a whitening agent such as a pigment, e.g., titanium dioxide, to increase the overall whiteness of the resultant material.

This construction can be ideal for two reasons in applications such as non-visible marker tracking during a live sporting event. First, if the markers are being placed upon the player's helmet, these helmets are often white and as such the whitened retroreflective material 100, 101, 102 and 103 will blend in and remain unnoticeable to the audience. Second, as mentioned in the background to this application, pigmentary titanium dioxide is reflective to UV energy and will help to increase the overall reflectivity to UV energy of the retroreflective material 100, 101, 102 and 103. It should be noted that if the binder 28 is to be composed of only substantially visibly transparent compounds, it is possible to used an agent such as Micronized Titanium Dioxide as produced by Collaborative Laboratories. Unlike pigmentary titanium dioxide, it is transparent to visible light while also being even more reflective of UV energy.

Once patent covering a variety of binder options is U.S. Pat. No. 5,650,213 (Rizika et. al.). In any case, a suitable binder material can be readily selected by those skilled in the art. Some illustrative examples of binder compositions that can be employed in retroreflective materials include thermoplastic, heat-activated, ultraviolet-cured, and electron beam-cured polymer systems. The binder 28 will in large part determine the flexibility of the overall retroreflective material 100, 101, 102 and 103 and should be selected accordingly.

Referring now to FIG. 1, there is shown the preferred embodiment of a monolayer of retroreflective element 20 as it interacts with the electromagnetic energy emitted by various lamps 10 such as a metal halide or xenon lamp. Since the lamp 10 is primarily intended to provide playing surface illumination for the audience, it will be emitting a broad spectrum of visible energy as rays 12. Visible rays 12 are transmitted directly through generic retroreflective element 20 (or 21) thereby providing the ideal effect of causing the retroreflective material such as 100, 101, 102 and 103 to remain substantially “invisible” to the human eye. By-product energy such as UV rays 11 in the case of metal halide lamps or IR rays 13 in the case of xenon lamps is also emitted by lamp 10 and is conversely retroreflected by elements 20uv and 20ir causing rays 11r and 13r respectively. Elements 20uv and 20ir are similar to each other in physical construction except that their reflectors 24uv and 24ir are made of differing materials designed to specifically reflect only the intended wavelength. As previously mentioned, materials such as Micronized Titanium Dioxide from Collaborative Laboratories, the thin film circular polarizer from CLCEO Corp. or the multilayer dielectric specified in the McDonnel Douglas patents could be used as the UV reflector 24uv. At least the polarizer from CLCEO Corp. can also be used as the IR reflector 24ir. This retroreflective action of elements 20uv and 20ir creates the desired and novel effect of causing the materials 100, 101, 102 and 103 to be detected by UV- or IR-based cameras such as 30a and 30b, respectively, but again being substantially undetectable by the human eye.

The present inventors anticipate the creation of retroreflective materials comprising retroreflective elements such as 20 and 21 of various reflector materials engineered to reflect a specific band of non-visible energy such as but not limited to UVB, UVA, near IR and/or far IR. Furthermore, it is also anticipated that retroreflectors that work within a narrow band of visible light are of significant benefit to at least machine vision applications where the light source may itself be of a narrow band of energy, e.g., red light. The state of the art, commercially available, motion analysis systems such as HiRES 3D from Motion Analysis Corporation currently work in the red band of visible energy while using retroreflectors that reflect the entire visible spectrum. This leaves open the possibility for spurious non-red band visible energy to be received into the tracking cameras thereby making image analysis more difficult. One way to eliminate these additional signals is to place red light transmissive filters upon the tracking cameras. If the retroreflective material were limited to the red band of visible frequencies, then the need for additional red light transmissive filters would be reduced.

Construction of materials 100 to retroreflect multiple simultaneous distinct frequency bands is anticipated to be quite useful. The present inventors are claiming the construction of retroreflective materials using two or more retroreflective elements, each being coated with a reflector uniquely reflecting a select narrow band of energy. These bands of reflected energy may or may not be within the range of ultraviolet, visible or infrared.

With respect to the requirements for a wider angle of observation, it is well known in the art that the size of the microspheric bead determines its index of refraction. The larger the index of refraction the further off parallel the reflected rays such as rays 11r and 13r will be directed back towards the light source, essentially increasing the angle of observation. Microspheres with an index below about 1.5 tend to be quite soft and lack transparency while those having an index above about 2.3 tend to be colored and also have low transparency. In the preferred embodiment, the monolayer of microspheres comprises a mixture of one, two, or more sizes of beads, each size having a different index of refraction. The optimum bead size and therefore index of refraction is best chosen based upon two factors. First, there is the known minimum and maximum distance between the pre-existing matrix of lamps 10 within the sporting arena and the newly installed tracking cameras such as 30a and 30b. And second, there is the known vertical distance between the playing surface and the lamp-camera combination. In combination, these two factors dictate the ideal indices of refraction to create a wide enough observation angle without needlessly reducing the amount of retroreflected energy. Of course, these ideal indices dictate the desired bead sizes.

Referring now to FIG. 3a there is shown an alternate embodiment 104 comprising retroreflective element 20fa that is similar in construction and function to elements 20, 20uv and 20ir except that it additionally comprises fluorescent matrix layer 23 that has been placed between microscopic bead 22 and reflector 24. Matrix layer 23 can be composed of, for instance, a polymer that holds a fluorescent compound such as a laser dye. Many examples of such dyes are well known in the art and can be selected to emit within the non-visible spectrum such as UV and IR. Such dyes could also be selected to emit a narrow band of energy within the visible spectrum, for instance red light. Retroreflective fluorescent materials constructed according to the disclosed teachings are capable of emitting more red light energy than the traditional retroreflectors used by companies such as Motion Analysis Corporation. These new materials will reflect the incident red light as normally expected and convert the frequencies of light just above red into red light for fluorescent-based emissions. Of course, other narrow bands of visible light energy could be augmented such as green light, using a different laser dye or similar fluorescent compound.

Referring now to FIG. 3b there is shown an alternate embodiment 105 comprising retroreflective element 20fb that is similar in construction and function to elements 20, 20uv and 20ir except that it comprises fluorescent bead 22f instead of transparent bead 22. Similar to embodiment 104, fluorescent bead 22f may be composed of, for instance, a polymer that holds a fluorescent compound such as a laser dye. This construction will offer advantages in the manufacturing process since it will be easier to mix the fluorescent materials with the polymer into a bead 22f than to add an additional layer such as 23. However, it should also be noted that the majority of absorption of the higher frequency energy would occur on the upper surface of bead 22f. Emitted energy of the lower desired frequency from this process will still radiate in 360° as with retroreflective element 20fa. Due to the distance between the upper surface of bead 22f and the reflector 24, the energy emitted due to fluorescence via material 105 is expected to have more of a diffuse characteristic than that of material 104.

Retroreflective materials such as 100, 101, 102 and 103 are important because, similar to the prior art, they work to maximize the reflected tracking signal while at the same time providing the novel function of remaining non-visible to the players and audience. Materials 104 and 105 provide the additional advantage of being able to convert illumination energy that may be readily existent in the visible spectrum into tracking signals within the non-visible spectrum. For instance, a typical metal halide lamp may have strong emissions in the visible red region at for instance 672 nm while having minimal emissions in the IR region, i.e. above 700 nm. Using appropriate compounds such as a laser dye, this visible energy may be absorbed and then re-emitted at a lower non-visible wavelength somewhere above 700 nm.

All novel teachings concerning the construction of visibly transparent wide angle retroreflective materials based upon microspheres are also directly applicable to cube corner or other optical bodies as will be well understood by those skilled in the art. The actual type of optical body such as a microscopic bead or cube corner is immaterial to the novel aspects of the present invention. What is important is that at least:

1 there is a substantially transparent optical body having an underside and an upper surface adapted to receive incident energy; and

2 there is a matrix of one or more compounds placed adjacent to the underside of the optical body and adapted to reflect a portion of the non-visible spectrum such as ultraviolet or infrared, or a sub-portion of the visible spectrum such as red light, while being substantially transmissive to all other energy.

Similarly, the fluorescent nature of the herein-disclosed retroreflective materials is also directly applicable to cube corner or other optical bodies as will be well understood by those skilled in the art. What is important is that at least there is a fluorescent material introduced into the optical body itself or embedded into a matrix layer placed between the optical body and the reflector.

Conclusion, Ramifications, and Scope of Invention

Thus, the present invention provides an apparatus and a method for:

1 providing a retroreflective material that is capable of retroreflecting electromagnetic energy outside of the visible spectrum, especially including ultraviolet and infrared energy, while remaining substantially transparent to visible light;

2 providing a retroreflective material that is capable of retroreflecting a narrow band of visible energy, for instance red light, while remaining substantially transparent to all other electromagnetic energy;

3 providing a retroreflective element that employs fluorescent materials to receive incident energy about one wavelength and emit energy about a second tracking wavelength, where the emitted energy is generally reflected back in the direction of the incident energy;

4 providing a retroreflective material capable of retroreflecting two or more different bands of electromagnetic energy; and

5 providing a retroreflective material capable of performing all of the advantageous functions and having all of the beneficial features of known retroreflective materials, especially that of having a wide angle of observation.

From the foregoing detailed description of the present invention, it will be apparent that the invention has a number of advantages, some of which have been described above and others that are inherent in the invention. Also, it will be apparent that modifications can be made to the present invention without departing from the teachings of the invention. For instance:

1 the binder matrix does not have to be substantially transmissive to the frequencies of electromagnetic energy that are not intended to be retroreflected unless the optical bodies are completely embedded within the binder, but rather could be reflective and in the case of the visible spectrum colored to match the substrate by adding selective pigments;

2 similarly, if a coating is used to encapsulate the retroreflective elements, then this coating must only be transmissive to the band of electromagnetic energy that is intended to be retroreflected;

3 the optical bodies do not have to be microscopic beads or cube corners and may be of a different shape or multi-configuration known or as of yet unknown but rather must simply follow the basic teachings of retroreflective elements and include a reflector that is limited to either a sub-portion of the visible spectrum or a portion of the non-visible spectrum such as ultraviolet or infrared;

4 the narrow band fluorescent matrix layer could be used in combination with an aluminum or silver broad band reflector as taught in the prior art in which case it would be expected to substantially increase the amount of energy emitted of a specific frequency such as red light. This in anticipated because the fluorescent material will tend to absorb the frequencies slightly higher than, for instance, red light and convert this energy into emitted red light thereby adding to the already incident and retroreflected red light. Note that the broad-spectrum incident energy both of a higher and lower frequency than the absorbed energy will continue to transmit through the fluorescent dye and retroreflect according to existing teachings. It is further anticipated that such an arrangement will tend to exhibit a wider angle of observation due to the omni-directional emission of the fluorescence process. These omni-directional emissions will cause reflections from the reflector back through the bead at angles not necessarily parallel to that of the incident energy; and

5 the fluorescent matrix could be chosen to emit at a visible frequency separate from the non-visible tracking energy. This emission could serve as a visible indicator to human observers that the retroreflective material has been properly bathed in the non-visible energy tracking energy.

One particular exemplary application of these novel retroreflective materials 100, 101, 102 and 103 as well as fluorescent retroreflective materials 104 and 105 is a machine vision system for following the motion of hockey players and their equipment in a live sporting event. The present inventors addressed the preferred embodiment and operation of such a system in their copending applications entitled Multiple Object Tracking System and Employing Non-Visible By-Product Energy for Object Tracking, both of which are incorporated by reference.

Referring to FIG. 4, there is shown a top view of the preferred exemplary application of the present invention. The system 200 comprises an array of overhead x-y camera assemblies 120c that individually track all object movement within a fixed area such as 120v. In total, the array of overhead assemblies 120c track all movements on the ice playing surface 102, and in team boxes 102f and 102g, penalty box 102h as well as a portion of the entrance-way 102e. Assemblies 120c further comprise a filming camera 125, a rink lamp 10 such as a Metal Halide HID lamp, and a tracking camera 124 onto which is attached a visible energy filter 124f, all of which are housed in an assembly casing 121 and have a view to the ice surface 102 below through the assembly Plexiglas 121a. Rink lamp 10 emits unused UV energy 11 such as the UV frequencies emitted by a Metal Halide lamp that radiates down onto surface 102 and off the objects moving upon this surface such as the player 110 and the puck 103.

Also tracking movements on a selected portion of ice surface 102 are perspective z tracking camera sets 130 that are situated as one pair at both ends of the playing surface 102. And finally there are automatic filming cameras 140 which are constantly being directed to the center of play as represented by player 110 who is currently controlling puck 103. Automatic filming cameras 140 are in continuous communication with and are receiving their directions from a local computer system 160 for video processing and analysis. System 160 itself is also in continuous communication with the array of overhead x-y tracking camera assemblies 120c and perspective z tracking camera sets 130. Local system 160 is further in optional communication with a remote computer system 170 for reviewing captured events that has attached viewing monitor 127 that displays the scene 128.

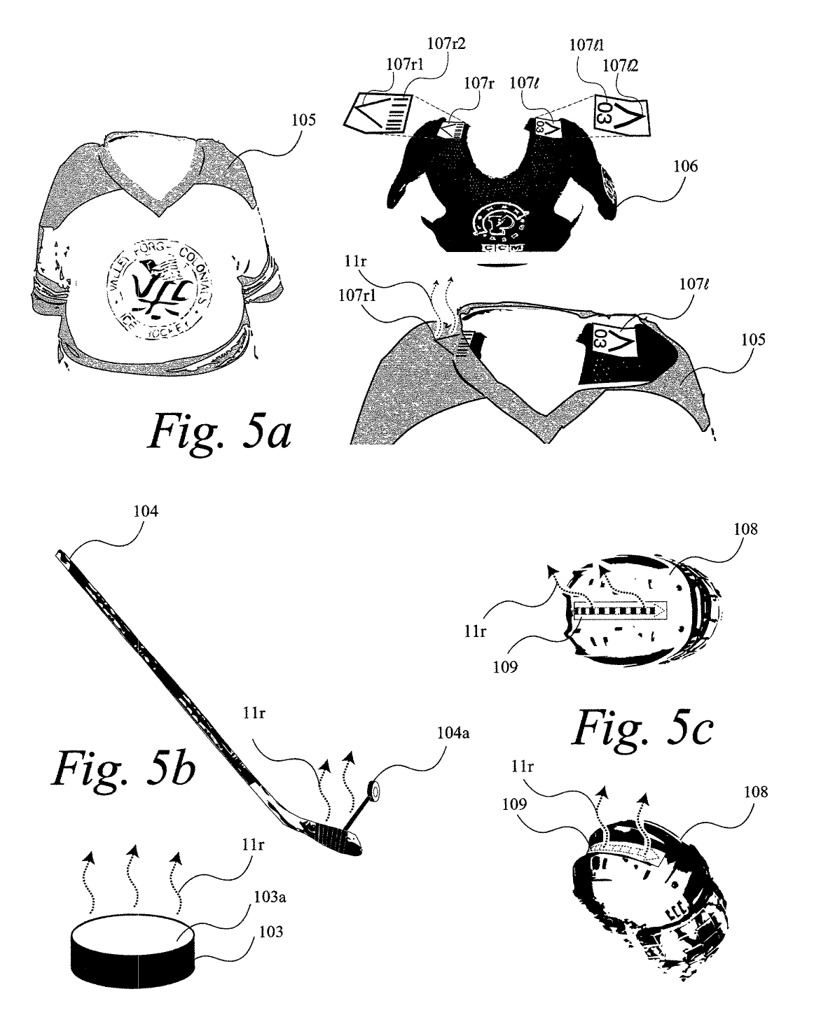

Referring now to FIG. 5a, there is depicted a typical player's jersey 105 and player's shoulder pads 106. Affixed to pads 106 are right shoulder team patch 107r and left shoulder player patch 107l. Patch 107r comprises orientation mark 107r1, which is an arrowhead pointing away from the head towards the arm and team indicia 107r2, which is a unique bar code. Patch 107l comprises orientation mark 107l1 that is an arrowhead pointing away from the head towards the arm and player indicia 107l2 that is a unique number. It should be noted that the indicia on patches 107r and 107l are created from either reflective material 20a, retroreflective material 20b or fluorescent material 20c. Also referring to FIG. 5a, there is depicted jersey 105 placed over pads 106. Note that jersey 105 is also shown to be cut-away for a full view of underlying player patch 107l. Also depicted in FIG. 5a is reflected UV energy 11r, such as reflective rays r1, retroreflected rays r2 or fluorescent rays r3, that is shown radiating though transmissive jersey 105.

Referring now to FIG. 5b, there is shown a typical hockey puck 103 where its top surface has (and in practice all outer surfaces have) been coated with a reflective ink 103a such as either reflective material 20a, retroreflective material 20b or fluorescent material 20c. Also depicted is a typical hockey stick 104 where its blade has been wrapped with a special reflective hockey tape 104a that is made of similar reflective material 20a, retroreflective material 20b or fluorescent material 20c. And finally depicted in FIG. 5b is reflected UV energy 11r, such as reflective rays r1, retroreflected rays r2 or fluorescent rays r3, that is shown radiating off both puck 103 and stick 104.

Referring now to FIG. 5e, there is shown both a top and perspective view of a typical hockey player's helmet 108 where a reflective sticker 109 has been applied to its top surface and is made of similar reflective material 20a, retroreflective material 20b or fluorescent material 20c. Also depicted in FIG. 5c is reflected UV energy 11r, such as reflective rays r1, retroreflected rays r2 or fluorescent rays r3, that is shown radiating off helmet 108.

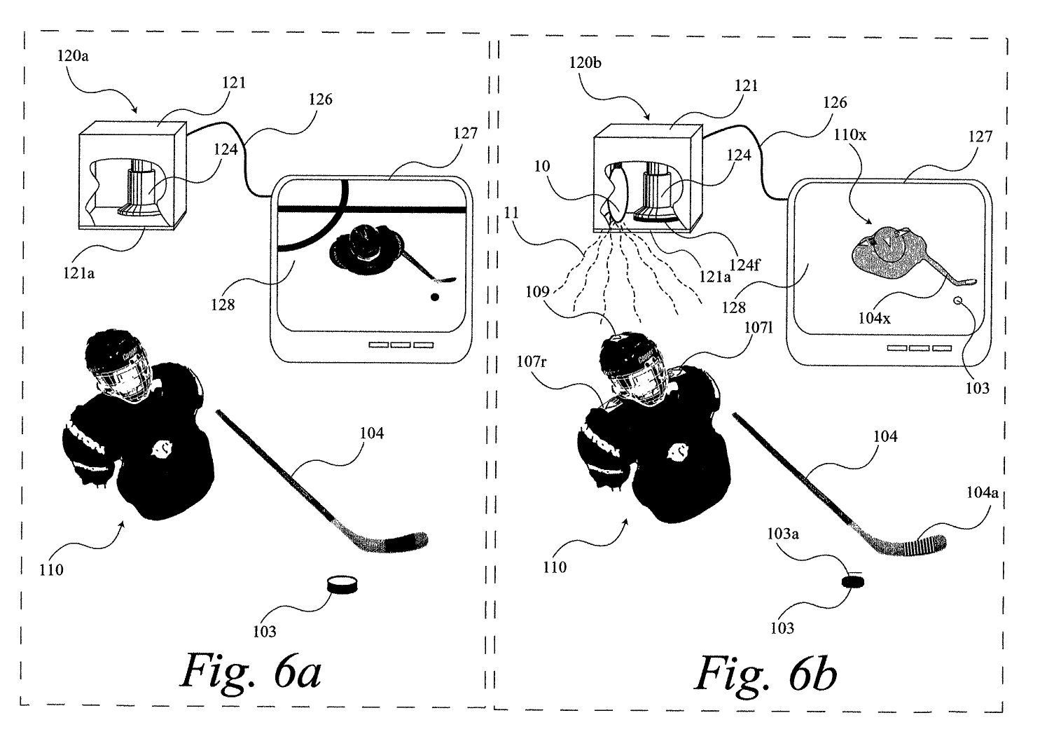

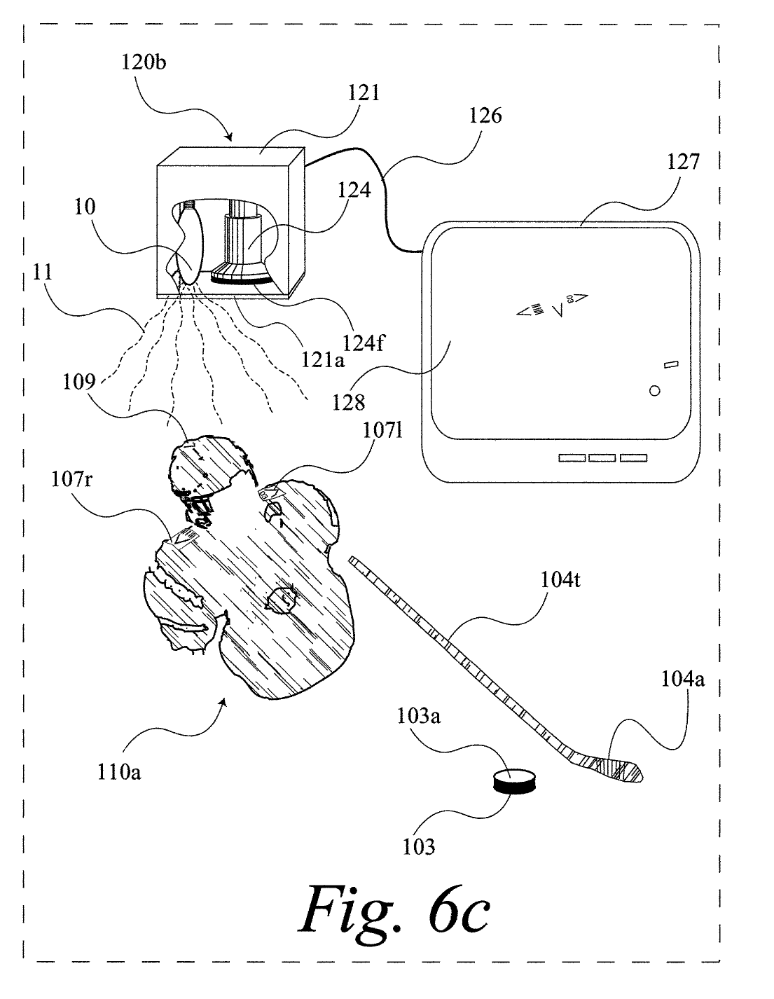

Referring now to FIG. 6a, there is shown a first embodiment of the overhead x-y tracking camera assembly 120a. In this embodiment, assembly 120a includes rink lamp 10 and tracking camera 124 (without visible energy filter 124f) which is enclosed within assembly casing 121 and has a view to the ice surface 102 below through assembly Plexiglas 121a. There is depicted below assembly 120a unmarked player 110, unmarked stick 104, and unmarked puck 103. Also shown is cable 126 which attaches assembly 120a to local computer system 160 (not depicted), to remote computer 170 (also not depicted), and therefore to viewing monitor 127 that displays scene 128. Referring now to FIG. 6b, there is shown a second embodiment of the overhead x-y tracking camera assembly 120b. In this embodiment, tracking camera 124 has been modified to include visible energy filter 124f. Note that pads 106 of player 110 have been augmented to include right shoulder team patch 107r and left shoulder player patch 107l. Also note that puck 103 now includes reflective ink 103a and that stick 104 has been wrapped with a special reflective hockey tape 104a. Scene 128 now depicts a different set of information to be analyzed and tracked such as a “dimmed” image of player 110 depicted as player 110x and a “dimmed” image of stick 104 depicted as stick 104x. In addition to these “dimmed” images of the foreground objects, the different set of information also includes “bright” images of the tracking marks that have been placed onto these same foreground objects such as patches 107r and 107l as well as ink marks 103a and tape 104a.

Referring now to FIG. 6c, the second embodiment of the overhead x-y tracking camera assembly 120b remains the same while the foreground objects have been additionally treated with a UV absorptive compound. These foreground objects are now shown as player 110a and stick 104t. Note that, in scene 128, player 110a and stick 104t are no longer visible.

It should be noted that the detailed operation of system 200 was first described in the present inventors' co-pending application entitled Employing Non-Visible By-Product Energy for Object Tracking. System 200 of the present invention is the same in both structure and operation as system 200 of the co-pending application with the following exceptions:

The co-pending description of system 200 provides for various methods of marking the objects to be tracked with a specially chosen, frequency-selective reflective material such as any of “reflective material (20a),” “retroreflective material (20b),” or “fluorescent material (20c).” These materials are then used to embed into puck 103 as reflective ink 103a, to produce reflective tape 104a, to embed into markings of patches 107r and 107t, and to produce reflective stickers 109 for helmets 108. The present invention adds the additional ability of marking all of the aforementioned objects 103, 103a, 104a, 107r, 107l, 108 and 109 with the novel retroreflective materials 100, 101, 102 and 103 as well as fluorescent retroreflective materials 104 and 105.

The operation of system 200 has been fully disclosed in the co-pending applications that were incorporated by reference. The use of the new materials 100, 101, 102, 103, 104, and 105 allows a machine vision system capable of tracking multiple objects within a predefined area to function completely within the non-visible spectrum while continuing to employ retroreflective markers. The use of fluorescent retroreflective materials 104 and 105 allows the system to convert visible light into a non-visible tracking energy such as infrared. This is advantageous since it can be used with either pre-existing or added light sources to create infrared tracking energy from visible light.

Accordingly, the scope of the invention is only to be limited as necessitated by the accompanying claims.

We claim:

1. A retroreflective structure comprising:
a substantially visually transparent optical body having an underside and an upper surface adapted to receive incident energy; and
a matrix of one or more compounds placed adjacent to the underside of the optical body and adapted to reflect a portion of the non-visible spectrum such as ultraviolet or infrared while being substantially transmissive to all other energy.

2. The retroreflective structure of claim 1 further comprising:
a matrix of one or more compounds forming a binder capable of holding a plurality of the optical bodies with adjacent reflectors where at least one reflector adjacent to one optical body reflects electromagnetic energy of a different band of frequencies than at least one other reflector adjacent to one other optical body.

3. The retroreflective structure of claim 1 further comprising:
one or more compounds embedded into the optical body that are capable of absorbing energy of one frequency and emitting energy of a second frequency.

4. A retroreflective structure comprising:
a substantially visually transparent optical body having an underside and an upper surface adapted to receive incident energy; and
a matrix of one or more compounds placed adjacent to the underside of the optical body and adapted to reflect a sub-portion of the visible spectrum while being substantially transmissive to all other energy.

5. The retroreflective structure of claim 4 further comprising:
a matrix of one or more compounds forming a binder capable of holding a plurality of the optical bodies with adjacent reflectors where at least one reflector adjacent to one optical body reflects electromagnetic energy of a different band of frequencies than at least one other reflector adjacent to one other optical body.

6. A retroreflective structure comprising:
a substantially visually transparent optical body having an underside and an upper surface adapted to receive incident energy;
a first matrix of one or more compounds placed adjacent to the underside of the optical body and adapted to absorb energy of one frequency and emit energy of a second frequency; and
a second matrix of one or more compounds placed adjacent to the underside of the first matrix and adapted to reflect a sub-portion of the visible spectrum while being substantially transmissive to all other energy.

7. A retroreflective structure comprising:
a substantially visually transparent optical body having an underside and an upper surface adapted to receive incident energy, into which one or more compounds have been embedded that are capable of absorbing energy of one frequency and emitting energy of a second frequency;
a second matrix of one or more compounds placed adjacent to the underside of the first matrix and adapted to reflect a sub-portion of the visible spectrum while being substantially transmissive to all other energy.

8. An automated system for following the movement of one or more marks placed upon one or more objects within a predefined area, the system comprising:
a visibly transparent retroreflective or fluorescent retroreflective ink forming at least one mark placed upon at least one object;
means for radiating energy throughout the predefined area;
means for receiving energy emanating from the one or more marks in response to the radiated energy; and
means responsive to the receiving means for determining the location of the one or more marks and therefore the location of the one or more objects onto which the marks have been placed.

9. An automated system for following the movement of one or more marks placed upon one or more objects within a predefined area, the system comprising:
a retroreflective or fluorescent retroreflective ink capable of receiving energy across the entire visible spectrum and emitting energy within a sub-portion of the visible spectrum forming at least one mark placed upon at least one object;
means for radiating energy throughout the predefined area;
means for receiving energy emanating from the one or more marks in response to the radiated energy; and
means responsive to the receiving means for determining the location of the one or more marks and therefore the location of the one or more objects onto which the marks have been placed.

10. An automated system for following the movement of one or more marks placed upon one or more objects within a predefined area, the system comprising:
a fluorescent retroreflective ink capable of receiving energy within a portion of the visible spectrum and emitting a non-visible tracking energy forming at least one mark placed upon at least one object;
means for radiating energy throughout the predefined area;
means for receiving energy emanating from the one or more marks in response to the radiated energy; and
means responsive to the receiving means for determining the location of the one or more marks and therefore the location of the one or more objects onto which the marks have been placed.
